(19) United States
(12) Patent Application Publication
(10) Pub. No.: US 2024/0331482 A1
(43) Pub. Date: Oct. 3, 2024

(54) DUAL USE OF A RECYCLING DRUM FOR RECYCLING BANKNOTES IN REGULAR OPERATION AND STORING BANKNOTES DURING FEEDING OPERATION

(71) Applicant: Crane Payment Innovations, Inc., Malvern, PA (US)

(72) Inventors: Thomas Cornu, Vulbens (FR); Patrick Vidonne, Andilly (FR); Sebastien Terrasson, Annecy (FR)

(21) Appl. No.: 18/577,663

(22) PCT Filed: Jul. 18, 2022
(86) PCT No.: PCT/US2022/073861

§ 371 Date: Jan. 8, 2024

Related U.S. Application Data
(60) Provisional application No. 63/222,846, filed on Jul. 16, 2021.

(51) Int. Cl. G07D 11/18; G07D 7/00; G07D 11/28; G07D 11/50; G07D 11/60

(52) U.S. Cl. CPC G07D 11/18; G07D 7/00; G07D 11/28; G07D 11/50; G07D 11/60

(57) ABSTRACT

A dual use of a recycler for recycling banknotes in a regular operation and storing banknotes during feeding operation and apparatus is provided. The banknote recycler (BNR) device includes a bunch note feeder, a recognition sensor, a plurality of recyclers, a transport path, and a processor. The bunch note feeder receives a banknote bunch. The recognition sensor verifies authenticity for each banknote in the bunch. Each of the plurality of recyclers temporarily stores designated banknotes. The transport path is provided between the bunch note feeder and the recyclers. The processor assigns a recycler as an escrow recycler; determines whether any banknotes of the bunch of banknotes is unacceptable; if a banknote is unacceptable, routes the unacceptable banknote to the escrow recycler; and after the bunch note feeder and transport path are empty, routes the unacceptable banknote from the escrow recycler along the transport path to an outlet.

### CROSS-REFERENCE TO RELATED APPLICATIONS

This application is a 371 National Stage of International Application No. PCT/US2022/073861, filed Jul. 18, 2022, which claims the benefit of U.S. Provisional Patent Application No. 63/222,846, filed Jul. 16, 2021, the disclosures of which are incorporated herein by reference.

### TECHNICAL FIELD

This disclosure relates generally to automated payment systems. More specifically, this disclosure relates to a dual use for a recycling drum within a banknote recycler (BNR) device or other system.

### BACKGROUND

During processing, a document not authenticated as a genuine banknote has to be returned to the user. In a BNR device, returning the banknote to the user implies reversing a document transportation direction. The possibility of reversing the document transportation direction prevents the BNR device from being able to simultaneously transport multiple documents, which is a new requirement linked to an introduction of a bunch note feeder module in the BNR device.

### SUMMARY

This disclosure provides a dual use for a recycling drum implementation within a BNR device or other system.

A dual use of a recycler for recycling banknotes in a regular operation and storing banknotes during feeding operation and apparatus is provided. The BNR device includes a bunch note feeder, a plurality of recyclers, a transport path, a recognition sensor, and a processor operably coupled to the bunch note feeder, the plurality of recyclers, the transport path, and the recognition sensor. The bunch note feeder is configured to receive a banknote bunch. Each of the plurality of recyclers is a recycling drum configured to temporarily store banknotes of a designated denomination. The recognition sensor is positioned along the transport path and configured to verify acceptance of each banknote in the received banknote bunch. The processor is configured to assign a recycler as an escrow recycler. The processor is also configured to identify at least one unacceptable banknote in the banknote bunch. The processor is additionally configured to route the at least one unacceptable banknote to the escrow recycler based on the determination. The processor is further configured to, after the bunch note feeder and the transport path are empty, route the at least one unacceptable banknote from the escrow recycler along the transport path to an outlet.

A dual use of a friction based recycling module for recycling banknotes in a regular operation and storing banknotes during feeding operation and apparatus is provided. The BNR device includes a bunch note feeder, a recognition sensor, a plurality of recycling drums, a transport path, and a processor. The bunch note feeder receives a bunch of banknotes. The recognition sensor verifies authenticity of an inserted banknote. The plurality of friction based recycling modules temporarily stores designated the banknotes. The transport path can be provided between the bunch note feeder and the friction based recycling modules. The processor assigns a friction based recycling modules as an escrow recycler; determines whether any banknotes of the bunch of banknotes is unacceptable; if a banknote is unacceptable, routes the unacceptable banknote to the escrow recycler; and after the bunch note feeder and transport path are empty, routes the unacceptable banknote from the escrow recycler along the transport path to an outlet.

In various embodiments, a banknote recycler device can include a bunch note feeder, a plurality of recyclers, a transport path, a recognition sensors, and a processor operably coupled to the bunch note feeder, the recognition sensor, the transport path, and the plurality of recyclers. The bunch note feeder can receive a banknote bunch. Each of the plurality of recyclers can be a recycling drum configured to temporarily store banknotes of a designated denomination. The transport path can transport banknotes in the banknote bunch between the bunch note feeder and each of the plurality of recyclers. The recognition sensor can be positioned along the transport path and can verify acceptance of each banknote in the received banknote bunch. The processor can assign one of the plurality of recyclers as an escrow recycler. The processor can also identify at least one unacceptable banknote in the banknote bunch. The processor can additionally route the at least one unacceptable banknote to the escrow recycler based on the identification. The processor can further, after the bunch note feeder and the transport path are empty, route the at least one unacceptable banknote from the escrow recycler along the transport path to an outlet.

In certain embodiments, to assign the escrow recycler, the processor can receive a user input identifying a specific recycler to use as the escrow recycler and can assign the escrow recycler based on the received user input.

In certain embodiments, the escrow recycler can be assigned based on a specified denomination of a recycler.

In certain embodiments, the escrow recycler can be assigned based on a depletion for each of the plurality of recyclers.

In certain embodiments, the processor can determine that the escrow recycler does not have a minimum space available for a replenish operation. The processor can also empty an amount of banknotes stored in the escrow recycler prior to receiving the banknote bunch to a bundler in order for the escrow recycler to have the minimum space available for the replenish operation.

In certain embodiments, the processor can when the escrow recycler is full, purge the transport path and route the at least one unacceptable banknote from the escrow recycler to the outlet.

In various embodiments, a method is provided for a banknote recycler. The method can include temporarily storing banknotes in a plurality of recyclers, wherein each of the plurality of recyclers is a recycling drum for banknotes of a designated denomination. The method can also include receiving a banknote bunch in a bunch note feeder. The method can additionally include assigning one of the plurality of recyclers as an escrow recycler. The method can further include transporting banknotes in the banknote bunch along a transport path between the bunch note feeder and each recycler of a plurality of recyclers. The method can also include verifying authenticity of each banknote in the received banknote bunch. The method can further include identifying at least one unacceptable banknote in the banknote bunch. In addition, the method can include routing the at least one unacceptable banknote to the escrow recycler based on the identification. The method can also include after the bunch note feeder and the transport path are empty, routing the at least one unacceptable banknote from the escrow recycler along the transport path to an outlet.

In certain embodiments, the method can also include receiving a user input identifying a specific recycler to use as the escrow recycler. The method can further include assigning the escrow recycler based on the received user input.

In certain embodiments, the escrow recycler is assigned based on a specified denomination of a recycler.

In certain embodiments, the escrow recycler is assigned based on a depletion for each of the plurality of recyclers.

In certain embodiments, the method can also include determining that the escrow recycler does not have a minimum space available for a replenish operation. The method can further include emptying an amount of banknotes stored in the escrow recycler prior to receiving the banknote bunch to a cashbox in order for the escrow recycler to have the minimum space available for the replenish operation.

In certain embodiments, the method can additionally include when the escrow recycler is full, purging the transport path and routing the at least one unacceptable banknote from the escrow recycler to the outlet.

In certain embodiments, the method can also include identifying an acceptable banknote of a denomination corresponding to the escrow recycler. The method can further include transferring the acceptable banknote to a bundler when the at least one unacceptable banknote is already stored on the escrow recycler.

In various embodiments, a banknote recycler device can include a bunch note feeder, a plurality of recyclers, a transport path, a recognition sensor, and a processor operably coupled to the bunch note feeder, the recognition sensor, the transport path, and the plurality of recyclers. The bunch note feeder can receive a banknote bunch. Each of the plurality of recyclers can be a friction based recycling module configured to temporarily store banknotes of a designated denomination. The transport path can transport banknotes in the banknote bunch between the bunch note feeder and each of the plurality of recyclers. The recognition sensor can be positioned along the transport path and can verify acceptance of each banknote in the received banknote bunch. The processor can assign one of the plurality of recyclers as an escrow recycler. The processor can also identify at least one unacceptable banknote in the banknote bunch. The processor can additionally route the at least one unacceptable banknote to the escrow recycler based on the identification. The processor can further, after the bunch note feeder and the transport path are empty, route the at least one unacceptable banknote from the escrow recycler along the transport path to an outlet.

In certain embodiments, to assign the escrow recycler, the processor can receive a user input identifying a specific recycler to use as the escrow recycler and can assign the escrow recycler based on the received user input.

In certain embodiments, the escrow recycler can be assigned based on a specified denomination of a recycler.

In certain embodiments, the escrow recycler can be assigned based on a depletion for each of the plurality of recyclers.

In certain embodiments, the processor can determine that the escrow recycler does not have a minimum space available for a replenish operation. The processor can also empty an amount of banknotes stored in the escrow recycler prior to receiving the banknote bunch to a bundler in order for the escrow recycler to have the minimum space available for the replenish operation.

In certain embodiments, the processor can when the escrow recycler is full, purge the transport path and route the at least one unacceptable banknote from the escrow recycler to the outlet.

Other technical features may be readily apparent to one skilled in the art from the following FIGURES, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a BNR device in accordance with various embodiments of the present disclosure;

FIG. 2A illustrates example banknote paths in a BNR device in accordance with various embodiments of the present disclosure;

FIG. 2B illustrates example banknote paths in a BNR device in accordance with various embodiments of the present disclosure;

FIG. 2C illustrates example banknote paths in a BNR device in accordance with various embodiments of the present disclosure;

FIG. 2D illustrates example banknote paths in a BNR device in accordance with various embodiments of the present disclosure;

FIG. 3 illustrates an example process for dual use of a recycling drum in a BNR device in accordance with various embodiments of the present disclosure;

FIG. 4 illustrates an example electronic device in accordance with various embodiments of this disclosure; and

FIG. 5 illustrates another example electronic device in accordance with various embodiments of this disclosure.

### DETAILED DESCRIPTION

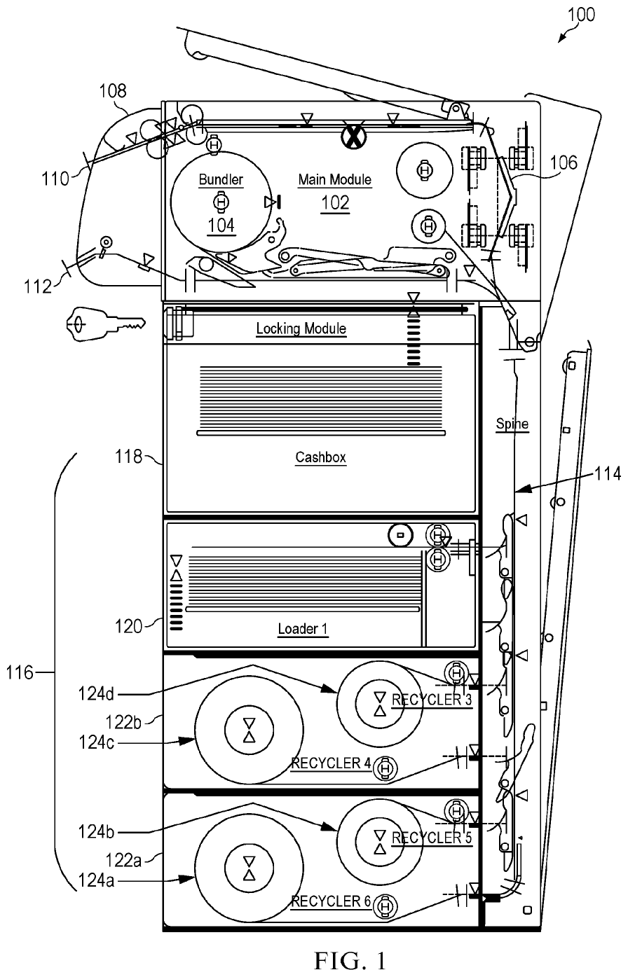

FIGS. 1 through 5, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, and cash may be used interchangeably herein to refer to a type of a negotiable instrument or any other writing that evidences a right to the payment of a monetary obligation, typically issued by a central banking authority. In addition, direction, orientation, or axis may be used interchangeably herein to refer to the direction of linear mechanical movement of components. In this specification terms banknote storing unit, banknote storage, banknote storing portion, tamper-evident storage, secured banknote storage may be used interchangeably herein to refer to a type of an instrument or any other device that may store currency from any systems incorporating a banknote acceptor.

The present disclosure relates to a BNR device that accepts banknotes from the user, verifies inserted banknotes, stores accepted banknotes, provides genuine currency back for change or cash-back and rejects non-genuine banknotes. The BNR device can be included in cashier safes, gaming machines, cashier-assisted automated cash handling systems, change providing systems, self-service terminals such as vending machines, ticket dispensers, photocopiers, ATMs, and the like. BNR devices generally have an opening where a customer or the user inserts single or multiple banknotes, a well-defined banknote path to convey banknotes from said opening to sensor systems, to a temporary cash storage and to a permanent banknote storage, said sensor systems to scan the banknotes and a computational system to determine if the inserted banknote is genuine or not, and where to send accepted banknote, i.e. to one of the temporary banknote storage units or to a permanent storage unit. The permanent banknote storage unit could be a cashbox with or without a stacking mechanism, a cash bag, or a box. The banknote storage unit is generally removable or has an opening for the operator to remove banknote from the banknote storage unit. In addition, many BNR devices may include multiple temporary storage units or escrow recycler before sending banknotes to the banknote storage unit. In addition, BNR devices may have a bunch note feeder that may allow insertion of a stack of banknotes for serial processing.

The BNR device sorts banknotes to individual storage locations and provides change at the end of the transaction. A deposit made by a previous customer may become change for the next customer. This arrangement of utilizing change, especially lower denomination banknotes result in the BNR device conducting more transactions compared to banknote acceptors that have similar banknote storage units as banknote acceptors store every accepted banknote into the storage units. In practice, this results in the BNR device carrying either lower capacity banknote storage units or having fewer cash pickups. As lower denominations are provided as change back to the users, higher denominations are accumulated in the storage units. This increases operational efficiency by executing more transactions per cash pickup as well as increases the value of cash pickup. Another additional benefit is the ability to provide cashback to the users in non-ATM devices. This cashback to the users reduces the accumulation of banknotes in banknote storage units as the reduced overflow of banknotes in deposit-withdrawal units results in more transactions before the banknote storage becomes full.

A subset of a BNR device comprises a banknote acceptor and a banknote dispenser machines in a larger envelope of a BNR device. These types of systems generally require more cash pickup and refills as one of the units is always accepting and filling up the banknote storage and the other unit is always dispensing and may run out of cash to dispense.

The embodiments of a document transport system illustrated in FIGS. 1-3 are for illustration only. FIGS. 1-3 do not limit the scope of this disclosure to any particular implementation of a document transport system.

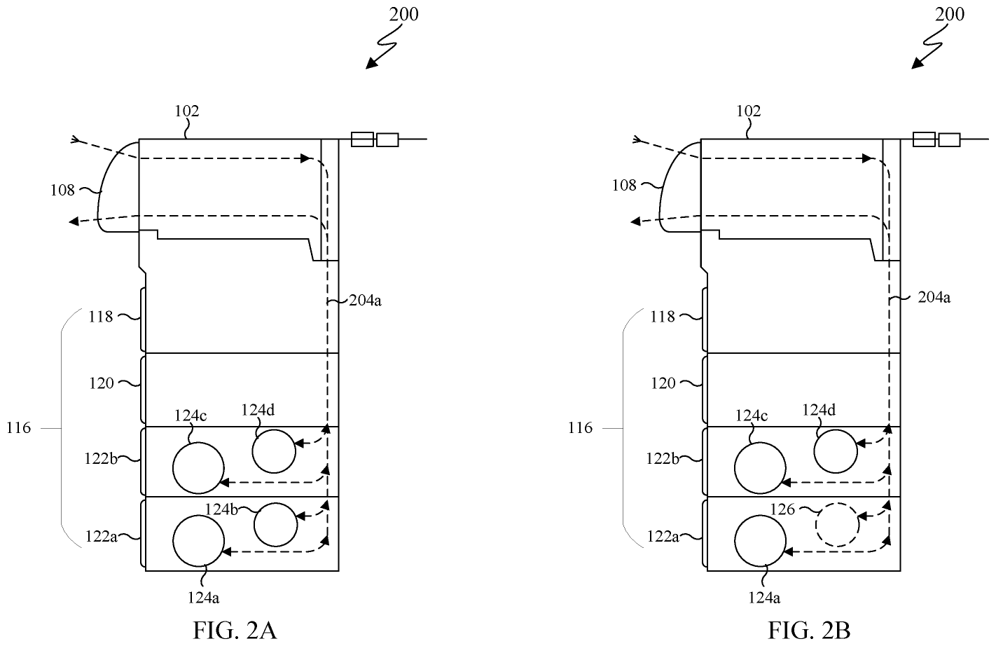

FIGS. 1-2B illustrate schematic views of BNR device 100 according to various embodiments of the present disclosure. FIG. 1 illustrates an example of a BNR device 100 in accordance with various embodiments of the present disclosure. FIG. 2A illustrates an example of a BNR device 100 in accordance with various embodiments of the present disclosure. FIG. 2B illustrates an example of a BNR device 100 in accordance with various embodiments of the present disclosure.

FIG. 1 illustrates a BNR device 100 according to various embodiments of the present disclosure. The BNR device 100 includes a banknote main module 102 including a bundler 104 and a recognition sensor 106, a payment bezel 108 including an inlet 110 and outlet 112, a spine 114, and one or more banknote boxes 116 including a cashbox 118, a loader box 120, and at least one recycler box 122. Banknote boxes 116 include temporary storage such as first and second recycler boxes 122, or escrow and a permanent storage such as cashbox 118. Each of the main module 102 and the banknote boxes 116 can be modular components of the BNR device 100, such that each of these components can be removed from the BNR device 100 for maintenance, jam correction, or other operations. The spine 114 can include components operable to support each of the main module 102, the banknote boxes 116, or other modules that can be installed in the BNR device 100. The spine 114 accommodates a banknote transportation path that transports banknotes from the main module 102 to one or more banknote boxes 116 and from one of the recycler boxes 122 or loader box 120 to the outlet 112. The modules can be arranged with the main module 102 above the banknote boxes 116. The spine 114 can also include transport mechanisms such as wheels or rollers, belts, or other banknote transport mechanisms used to transfer banknotes from one of the main module 102 or the banknote boxes 116 to another one of the modules. The recycler boxes 122 are described in greater detail below in regard to FIGS. 2A-2D.

The payment bezel 108 can be mounted to a front portion of the BNR device 100. For example, the payment bezel 108 can be mounted in front of the main module 102, such that banknotes introduced into the BNR device 100 via the payment bezel 108 enter the bundler 104 of the main module 102. The inlet 110 may also be referred to as a bulk note feeder that can accept a banknote bunch or a plurality of banknotes.

The bundler 104 of the main module 102 can include internal transport components to transport the banknote, such as wheels or rollers, belts, or other transport components to transport the banknote through an interior of the main module 102. The banknote can then be transferred via internal transport components to the recognition sensor 106 of the main module 102. Once the banknote is transferred to the recognition sensor 106 of the main module 102, imaging sensors or other components in the recognition sensor 106 of the main module 102 can view or otherwise detect banknotes traveling through the interior of the recognition sensor 106 of the main module 102. The recognition sensor 106 can include one or more of optical, ultraviolet (UV), infrared (IR), magnetic, capacitive or phosphorescence decay sensors.

If the banknote is accepted, the banknote can then be transported out of the main module 102 to another module of the BNR device 100, such as one of the recyclers 122, bundler 104, or the cashbox 118. In some embodiments, the rejected banknote can be first transferred to one of the recyclers 122 before being dispensed. In some embodiments, the recognition sensor 106 of the main module 102 can detect banknotes as the banknotes travel through the transportation path of the main module 102. In some embodiments, the transportation path of the main module 102 can pass banknotes to the recognition sensor 106 of the main module 102, and the recognition sensor 106 of the main module 102 can detect the banknotes and pass the banknotes back to the transportation path of the main module 102.

Based on the detected denomination of the banknote by the recognition sensor 106 of the main module 102, the banknote can be stored in an appropriate module of the BNR device 100 according to the detected denomination. The banknote detection components in the recognition sensor 106 of the main module 102 can be physically or communicatively coupled to a controller or processor and memory for controlling transport of the banknote based on the detection of the banknote, and for storing banknote characteristics of the detected banknote, such as serial numbers, denomination, orientation, series of banknote, or other characteristics, so that the BNR device 100 can track the banknote in the BNR device 100 and keep an accurate accounting of the banknotes stored in the BNR device 100.

As also illustrated in FIG. 1, each of the main module 102 and banknote boxes 116 can include openable panels that allow a user or operator to open the panel and access an interior portion of the main module 102. This allows the user or operator to access a banknote path inside each module. For example, while in the closed configuration, the banknote boxes 116 can be installed onto the spine 114 and operated in conjunction with the BNR device 100 to receive and dispense banknotes. The banknote boxes 116 each includes within an interior portion a plurality of transport mechanisms such as wheels, rollers, belts, or other transport mechanisms. For example, rollers can be operable to transport banknotes along a banknote path within each of the banknote boxes 116. Each of the main module 102 and banknote boxes 116 also includes one or more openable panels that allow for an operator to inspect inside portions of the BNR device 100, such as in the event of a banknote jam. For example, each banknote box 116 and the bundler 104 of the main module 102 can include one or more openable panels on a side exterior surface. Each openable side panel can be hingedly coupled to a side of a banknote box 116 or the bundler 104 of the main module 102 such that the side panel opens away from the side of the recycler box 122 or bundler 104 of the main module 102 and extends in a direction perpendicular to the banknote path when fully opened. Opening the one or more side panels grants access to at least some of the transport mechanisms inside the BNR device 100, and the banknote transport path, such that, if a banknote is jammed, the jam can be corrected.

In some embodiments, the main module 102 and/or banknote boxes 116 can include transparent windows, such as transparent glass or plastic portions, which are disposed at one or more of the openable panels, or elsewhere on various surfaces of the modules, such as a top surface overlooking the banknote path, to allow an operator or user to view banknotes either traveling through the banknote path, or jammed banknotes. For example, if one of the side openable panels includes a transparent surface, and a banknote becomes jammed in the area behind the openable panel, an operator or user would be able to see the location of the jam, open the side panel, and correct the jam. In some embodiments, the recognition sensor 106 of the main module 102, bundler 104 of the main module 102, and/or banknote boxes 116 can each also include an openable panel on a front portion of the recycler box 122 that can be hingedly connected such that the operator can view inside the module and reach into the module if needed to correct issues within the module.

As another example, the recognition sensor 106 of the main module 102 can also include an openable panel, such as an openable panel on a top surface that, when opened fully, extends up vertically from a top of the BNR device 100. While in the closed configuration, the recognition sensor 106 of the main module 102 can be installed onto the spine 114 and operated in conjunction with the BNR device 100 to detect and/or recognize banknotes and banknote characteristics. The recognition sensor 106 of the main module 102 includes, within an interior portion of the recognition sensor 106 of the main module 102, one or more banknote transport mechanisms. One or more passive rails can be placed opposite an active roller in the recognition sensor 106 of the main module 102. The active rollers are operable to transport banknotes along a banknote path within the recognition sensor 106 of the main module 102. While the recognition sensor 106 of the main module 102 is in the open configuration, an operator can inspect inside portions of the recognition sensor 106 of the main module 102, such as in the event of a banknote jam. For example, the openable panel on the top portion of the recognition sensor 106 of the main module 102 can be hingedly connected such that the operator can view inside the recognition sensor 106 of the main module 102 and reach into the recognition sensor 106 of the main module 102 if needed to correct issues within the recognition sensor 106 of the main module 102.

Opening the panel grants access to at least some of the transport mechanisms, such that, if a banknote is jammed at one or more of the transport mechanisms, the jam can be corrected. In some embodiments, the recognition sensor 106 of the main module 102 can include transparent windows, such as transparent glass or plastic portions, that are disposed at one or more of the openable panels, or elsewhere on various surfaces of the recognition sensor 106 of the main module 102, such as a top surface overlooking the banknote path on the openable panel of the top portion, to allow an operator or user to view banknotes either traveling through the banknote path, or jammed banknotes.

Bundler 104 is a sub-system with the ability to temporarily store a number of banknotes as a bundle. In certain embodiments, an escrow can be comprised of the bundler 104 along with an escrow recycler 124. During CashIn operations or banknote acceptance operations, bundler 104 can store genuine banknotes inserted by customer. If customer completes a transaction, banknotes stored on the bundler 104 are transferred to one or more of the recyclers 124 or to cashbox 118. If customer cancels a transaction, then banknotes stored on the bundler 104 are sent back to customer through outlet 112. During dispense operations or dispensing genuine banknotes, bundler 104 can store the genuine banknotes coming from the one or more recyclers 124 to create a bundle before presenting the bundle to the user. During replenish operations, bundler 104 can be used to store rejected banknotes when space needs to be made on escrow recycler 124. Banknotes stored on the bundler 104 can either be presented to the user through the device outlet 112 or be moved to the cashbox 118 or to one or more of the recyclers 124.

Although FIG. 1 illustrates an example of a BNR device 100, various changes may be made to FIG. 1. For example, the BNR device 100 could be used in automatic ticket seller machines, automatic teller machines, vending machines and other kiosks. Also, there could be more or less banknote boxes 116 than shown.

FIGS. 2A and 2B illustrate schematic views of proposed embodiments of a BNR device 100 in accordance with various embodiments of the present disclosure. FIG. 2A illustrates an example of a BNR device 200 in accordance with various embodiments of the present disclosure. FIG. 2B illustrates an example of a BNR device 200 in accordance with various embodiments of the present disclosure. FIG. 2C illustrates an example of a BNR device 201 in accordance with various embodiments of the present disclosure. FIG. 2D illustrates an example of a BNR device 202 in accordance with various embodiments of the present disclosure.

FIGS. 2A and 2B illustrate a BNR device 200 according to various embodiments of the present disclosure. FIG. 2A shows a BNR device 200 configured to receive multiple banknotes in bulk to verify the authenticity of the inserted banknotes in bulk. The payment bezel 108 (inlet 110 in FIG. 1) accepts banknotes either serially in single banknote insertion mode or in bulk in bulk banknote insertion mode. Banknotes are separated and transported towards the recognition sensor 106 of the main module 102 serially by a separation mechanism in a bunch note feed attached with the main module 102. Banknotes deemed not acceptable by the recognition sensor 106 or the main module 102 are returned to payment bezel 108 by the bundler 104 of the main module 102. Once a banknote box 116 is filled, after a certain amount of the transactions, or a fixed time, the specific banknote box module can be removed to collect banknotes from BNR device 200. The BNR device 200 also includes one or more recycler boxes 122 that can each house one or more recyclers 124 that dually function as a denomination recycler 124 and an escrow recycler 126. The banknote transportation path in the spine 114 transports all accepted banknotes into the recycler boxes 122 for temporary storage. Banknotes stored in the recycler boxes 122 are used to provide change to the users to complete a transaction. Banknotes dispensed from the recycler boxes 122 are sent by the banknote transportation path in the spine 114 to the payment bezel 108 to be dispensed to the user. In certain embodiments, the BNR device 200 can temporarily assign a recycler 124, such as a second recycler 124b, as an escrow recycler 126 when a bunch of banknotes are detected in the payment bezel 108 or other loading feature of the BNR device 200. The remaining first recycler 124a, third recycler 124c, and fourth recycler 124d are utilized in a normal manner to store banknotes of a respective denomination. The escrow recycler 126 can be assigned for unacceptable banknotes. Non-limiting examples of unacceptable banknotes can include foreign currencies, fraudulent currencies, unidentifiable currencies, or any other currency explicitly rejected by the operator or owner of the BNR device 200.

FIG. 2B illustrates a BNR device 200 according to various embodiments of the present disclosure. FIG. 2B shows how banknotes move inside a BNR device 200. Once a user has inserted banknotes either serially or in bulk in the inlet 110 of the payment bezel 108 (bunch note feeder) the banknotes are separated by a separation mechanism in the bunch note feeder, and then banknotes are sent serially by the banknote transportation module into the recognition sensor 106 of the main module 102. If a banknote is rejected by the recognition sensor 106 of the main module 102, then banknote is sent to a dual use recycler 124 in one of the recycler boxes 122. If a banknote is deemed acceptable by the recognition sensor 106 of the main module 102, then the banknote transportation module moves accepted banknote to either one of the recyclers 124 in one of the recycler boxes 122, the bundler 104, or to the cashbox 118. If a banknote is to be dispensed from one of the recyclers 124 of one of the recycler boxes 122, then the banknote is transported by banknote transportation path in the spine 114 into the main module 102 and then to the payment bezel 108.

FIG. 2C illustrates a BNR device 200 according to various embodiments of the present disclosure. FIG. 2C shows how banknotes move inside a BNR device 201 with six recyclers 124a-124f. Once a user has inserted banknotes either serially or in bulk in the inlet 110 of the payment bezel 108, the banknotes are further moved inside the main module 102 to a banknote separation area. Once the banknotes reach the separation area inside the main module 102, the banknotes are separated by a separation module, and then banknotes are sent serially by the banknote transportation module into the recognition sensor 106 of the main module 102. If a banknote is rejected by the recognition sensor 106 of the main module 102, then the banknote is sent to a dual use recycler 124 in one of the recycler boxes 122. If a banknote is deemed acceptable by the recognition sensor 106 of the main module 102, then the banknote transportation module moves the accepted banknote to either one of the recyclers 124a-124f in one of the recycler boxes 122, bundler 104, or to the cashbox 118. If a banknote is to be dispensed from one of the recyclers 124 of one of the recycler boxes 122, then the banknote is transported by the spine 114 into the main module 102 and then to the payment bezel 108.

FIG. 2D illustrates a BNR device 202 according to various embodiments of the present disclosure. FIG. 2D shows how banknotes move inside a BNR device 202 with two recyclers 124a and 124b. Once a user has inserted banknotes either serially or in bulk in the inlet 110 of the payment bezel 108, the banknotes are further moved inside the main module 102 to a banknote separation area. Once the banknotes reach the separation area inside the main module 102, the banknotes are separated by a separation module, and then banknotes are sent serially by the banknote transportation module into the recognition sensor 106 of the main module 102. If a banknote is rejected by the recognition sensor 106 of the main module 102, then the banknote is sent to a dual use recycler 124 in one of the recycler boxes 122. If a banknote is deemed acceptable by the recognition sensor 106 of the main module 102, then the banknote transportation module moves the accepted banknote to either one of the recyclers 124 in one of the recycler boxes 122, bundler 104 or to the cashbox 118. If a banknote is to be dispensed from one of the recyclers 124 of one of the recycler boxes 122, then the banknote is transported by the spine 114 into the main module 102 and then to the payment bezel 108.

The banknote transportation path in the spine 114, as explained in FIGS. 2A-2D, moves banknotes between the main module 102 and the different banknote boxes 116. The banknote transportation path in the spine 114 functionally bi-directional but operates during a feeding transaction in a unidirectional manner. In other words, the banknote transportation path in the spine 114 can move banknotes in both directions but is functionally operated in one direction without reversing the banknote mid traversal of the banknote transportation path in the spine 114. During single banknote insertion, if a banknote is deemed not acceptable then the banknote transportation path in the spine 114 reverses banknote transportation direction and sends the unaccepted banknote to outlet 112 of the payment bezel 108. This reversal of the banknote transportation path in the spine 114 may result in jam if there is more than one banknote in the banknote transportation path in the spine 114. During bunch banknote insertion, the banknote transportation path in the spine 114 operates in only one direction. This results in the unacceptable banknote being routed to one of the recyclers 124 that is designated as the escrow recycler 126.

The banknote boxes 116, except for temporary storage, store high value denominations banknotes and excess banknotes, and dispense banknotes from the temporary storage. The banknote boxes 116 include one or more cashboxes 118, one or more loaders 120, and one or more recycler boxes 122. The cashbox 118 is a container that higher currency or extra banknotes get inserted into.

The recycler box 122 is a module that contains one or more recyclers 124 for temporarily storing banknotes. A recycler 124 can also be referred to as a recycler drum. The recycler box 122 can include one or more recyclers 124, for example, each recycler box 122 can hold two recyclers 124 for different denominations for banknotes. However, each recycler box 122 can have a different number of recyclers 124. Each recycler 124 can be designed for a specific denomination of a banknote. Non-designated denominations of banknotes can be sent to the cashbox 118 for storage until a user empties the cashbox 118. For example, in US currency, recyclers 124a-124d can be designed to respectively hold $1, $5, $10, and $20 banknote denominations. When $2, $50, and $100 banknote denominations are detected, these banknotes are sent to the cashbox 118.

In certain circumstances, a recycler 124 can be used as an escrow recycler 126 for unaccepted banknotes. For instance, the main module 102 can detect that a bunch of banknotes are received and one of the recyclers 124 can be designated as an escrow recycler 126. Unaccepted banknotes are routed to the escrow recycler 126 as they are detected. Once the bunch of banknotes has been processed, the unacceptable banknotes are routed from the escrow recycler 126 to the outlet 112 of the payment bezel 108.

The escrow recycler 126 criteria can include that a recycler 124 is not in a specified list, a recycler 124 is not full, a lower capacity recycler 124 is selected before a higher capacity recycler 124, the highest value between two remaining recyclers 124, etc. The highest value between two remaining recyclers 124 can be determined by excepting a highest value count for a recycler 124 at greater than half a capacity and a low value count for a recycler 124 at less than half a capacity.

The loader box 120 is a module that a stack of banknotes can be inserted into the BNR device 100 to reload the recyclers 124 in the recycler boxes 122. In certain embodiments, the modular slot in the BNR device 100 for the loader box 120 is interchangeable with an extra recycler box 122.

In certain embodiments, a friction-based recycling system can be implemented in the BNR device 100 instead of recyclers 124. The friction-based system operates using friction-based rollers that are pressed against a flat stack of banknotes. The friction-based system requires less space within recycler box 122, which in turn allows for storage of more banknotes. The friction-based system can draw banknotes from the top or bottom of a stack of banknotes stored in the recycling box. In certain embodiments, certain recycler boxes 122 in the system could be friction based and others could be drum based.

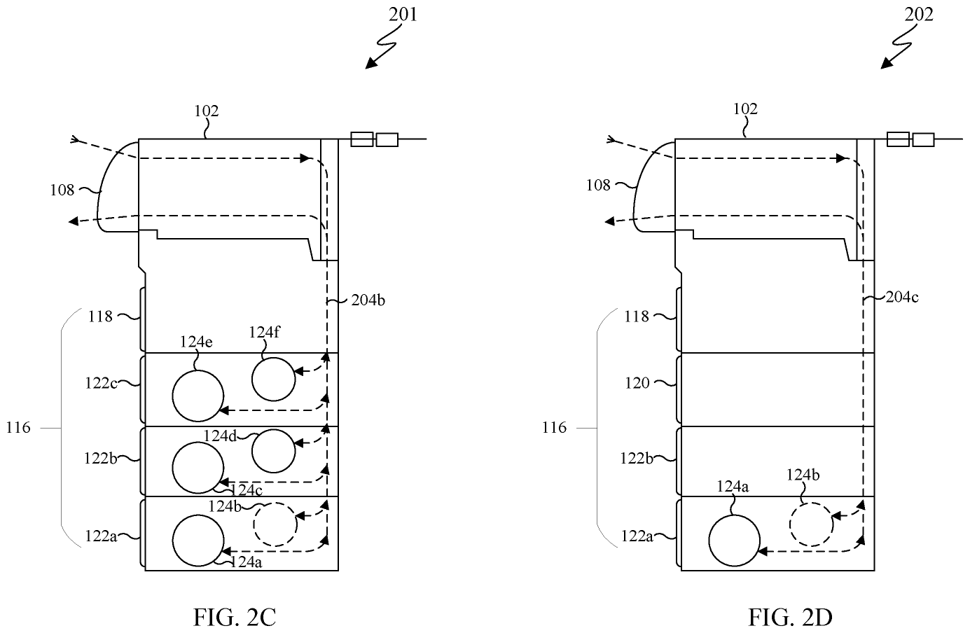

FIG. 3 illustrates an example method 300 for dual use of a recycler 124 for recycling banknotes in regular operation and storing banknotes during feeding operations according to this disclosure. For ease of explanation, the method 300 of FIG. 3 is described as being performed using the BNR device 100 of FIGS. 1-2D. However, the method 300 may be used with any other suitable system and any other suitable BNR device.

As shown in FIG. 3, the replenish event can provide a set of commands to replenish one or several recyclers at a higher speed. The commands can include a bnr_replenishstart command to enable a replenish transaction, a bnr_replenish command to execute replenishment or process an inserted bunch of banknotes, and a bnr_replenishend command to complete a replenish transaction. The bnr_replenishstart command involves the steps 302-308. The bnr_replenish command involves steps 310-332. The bnr_replenishend command involves terminating the replenish transaction by putting the BNR device 100 back to a default state.

The BNR device 100 can detect a replenish event and begin a replenish process in step 302. A replenish event could include an input received from an operator to the BNR device 100 or a bunch of banknotes loaded into the BNR device 100, such as in the inlet 110 or the loader box 120. For example, the BNR device 100 could detect a bunch of fifty banknotes to handle. A replenish process is a process for replenishing the recyclers when the recyclers have become depleted or close to depleted. Replenishment ends when no more banknotes are present in the loader box 120, when all recyclers to replenish are full, when an escrow recycler 126 is full, or after a transaction controller has sent a cancel command to the BNR device 100. Before completion of the command, rejected banknotes are returned to the user in a bunch through the outlet 112. The BNR device 100 checks that pre-conditions are acceptable to execute replenishment. The replenish process occurs in relation to a recycler list. The recycler list can include default amounts of specific denominations for each recycler.

The BNR device 100 sets a recycler 124 as an escrow recycler 126 according to predefined rules in step 304. In certain embodiments, the BNR device 100 can provide an option to the user for selecting an escrow recycler 126. If a selection is not made by a user/operator, then the BNR device 100 can make the selection according to the predefined rules and a current status of the recyclers 124 in the BNR device 100. The predefined rules could include, for example, the denominations specified for each of the recyclers 124. The determination by the BNR device 100 can be made based on predefined settings, depletion of recyclers 124, etc. if a rule specifies an excluded list of recyclers 124, the BNR device 100 will select an escrow recycler 126 absent from the list. If a rule specifies all recyclers 124 are available or does not indicate any rules for recyclers 124, the BNR device 100 will select an escrow recycler 126 among the recyclers 124. The escrow recycler 126 must have enough free space to allow replenishment at full speed. For example, an escrow recycler 126 should have space for three banknotes. For maximizing replacement at full speed, the escrow recycler 126 should have space for at least six banknotes. If the free space of escrow recycler 126 falls below a limit that allows replenishment at full speed, the BNR device 100 reduces a replenish cadency to ensure that the number of banknotes in the transport system does not exceed a free space of an escrow recycler 126. If the free space of the escrow recycler 126 falls below a specified amount, the banknote feeding from the bunch note feeder is paused, rejected banknotes are moved from the escrow recycler 126 to the bundler 104, and then banknote feeding is resumed at full speed.

The BNR device 100 can determine whether a minimum space in the escrow recycler 126 is available in step 306. This ensures enough space is available in the escrow recycler 126. If necessary, the BNR device 100 moves some accepted banknotes on the recycler 124 selected as the escrow recycler 126 to the bundler 104. The minimum space can be determined based on an amount of banknotes for a specified currency, size of the recycler 124, a predetermined amount, etc. When the recycler 124 selected as the escrow recycler 126 does not have the minimum space available, the BNR device 100 empties an amount of banknotes from the recycler 124 until the minimum space is available in step 308. An amount of banknotes in excess of the minimum space can be sent to the bundler 104. This will allow unacceptable banknotes to be stored over accepted banknotes that had previously been supplied to the recycler 124.

When a minimum space on one or more of the recyclers 124 is available, the BNR device 100 waits for banknotes to be inserted into a bunch note feeder in step 310. In certain embodiments, the bnr_replenish command can prepare the BNR device 100 to receive a bunch of up to 50 banknotes. The BNR device 100 begins handling the banknotes once detected in the bunch note feeder in step 312. The banknotes can be processed at a maximum speed. The maximum speed can be determined based on a number of factors, including speed of the transport mechanism, speed to not cause a banknote jam, etc. Opposed to a BNR without an escrow recycler (or other escrow function), the maximum speed does not need to consider speed, pauses, or delays for returning or rejecting unacceptable banknotes.

The BNR device 100 determines whether the banknote is accepted at step 314. The recognition sensor 106 can identify banknotes that are inserted into a bulk note feeder that are not of one of specified currencies accepted by the BNR device 100. Non-limiting examples of banknotes that could not be accepted include foreign banknotes, banknotes of denominations rejected by the BNR device 100, fraudulent banknotes, etc.

When the banknotes are not accepted, the BNR device 100 routes the banknote to the escrow recycler 126 for temporary storage in step 316. The unaccepted banknotes can be stored in series on top of any specified banknotes normally stored on the recycler 124 prior to the replenish event. and assignment as an escrow recycler 126. The BNR device 100 can determine whether the minimum space for the escrow recycler 126 has been reached in step 318. The minimum space in the escrow recycler 126 can depend on a minimum number of banknotes in parallel in the transport system and a margin (in banknotes) from a max speed. In certain embodiments, the minimum space can also be the maximum amount of banknotes that a recycler 124 can hold. When the minimum space has been reached, the BNR device 100 purges the banknote transportation path by stopping new banknotes feeding from the bunch note feeder in step 324. In other words, banknotes in the transportation path can be appropriately routed to respective recyclers 124 or the escrow recycler 126. The BNR device 100 empties an amount of banknotes from the escrow recycler 126 to the bunch unit. When the minimum space has been reached for the escrow recycler 126, the BNR device 100 can determine that the reject escrow recycler 126 and the bundler are full in step 328. In certain embodiments, the escrow refers to both the reject escrow recycler 126 and the bundler. When the minimum spaced is not reach in the escrow recycler 126 in step 318, the process proceeds to determine whether the escrow recycler is full in step 328.

When the banknote is accepted in step 314, a denomination of the banknote is determined, and the banknote is routed to the specified recycler 124 corresponding to the denomination in step 320. When routing the banknote to the recycler 124 designated as the escrow recycler 126, the BNR device 100 determines whether the escrow recycler 126 contains rejected banknotes in step 322. When the escrow recycler 126 contains rejected banknotes, the BNR device 100 purges the banknote transportation path by stopping new note feeding in step 324. When the new note feeding is completed, the BNR device 100 empties a specified amount of banknotes from the escrow recycler 126 to the bunch unit in step 326. After emptying the escrow recyclers 126 or when the escrow recycler 126 currently does not have any rejected banknotes, the currency processing apparatus can determine whether the reject escrow recycler 126 is full. When the escrow recycler 126 is full, the BNR device 100 refunds or returns the rejected banknotes from the escrow recycler in step 332.

When the reject escrow recycler 126 is not full, the BNR device 100 determines whether the bunch note feeder is empty in step 330. When the bunch note feeder is not empty, the BNR device 100 returns to processing the bunch of banknotes at maximum possible speed at step 312. The maximum speed is updated by a number of banknotes in parallel in the transport system. The maximum speed also depends on a maximum system capacity and a reject escrow recycler 126 amount of free space, including the space in the escrow recycler 126 and in a bundler 104. When the bunch note feeder is empty or when the reject escrow recycler 126 is full, the BNR device 100 refunds or returns the rejected banknotes that are temporarily stored on the escrow recycler 126. The reject escrow recycler 126 free space is updated according to free space in escrow recyclers 126 and free space in the bundler 104. The bnr_replenishend command involves terminating the replenish transaction by putting the BNR device 100 back to a default state.

Although FIG. 3 illustrates one example of a method for dual use of a recycler for recycling banknotes in regular operation and storing banknotes during feeding operations, various changes may be made to FIG. 3. For example, while shown as a series of steps, various steps in FIG. 3 may overlap, occur in parallel, or occur any number of times.

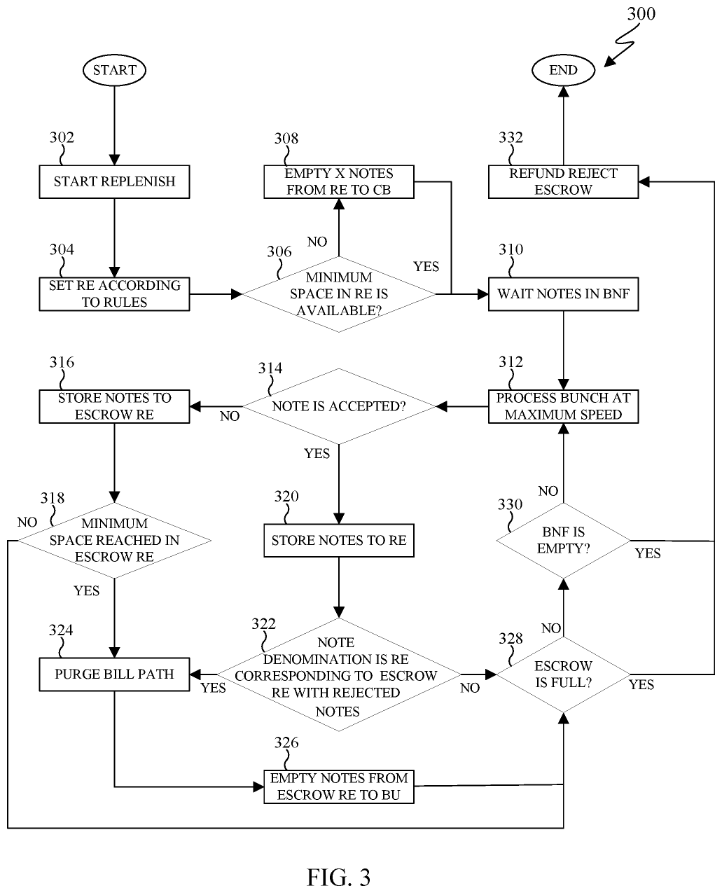

FIG. 4 illustrates an example electronic device 400 in accordance with various embodiments of this disclosure. The device 400 can be one example of a BNR system. The system 400 can include a controller (e.g., a processor/central processing unit (“CPU”)) 402, a memory unit 404, and an input/output (“I/O”) device 406. The device 400 also includes at least one network interface 408, or network interface controllers (NICs). The device 400 further includes at least one capture device 410 for capturing media or inputs to the system through an I/O device. In some embodiments, the capture device is not included. The device 400 also includes a storage drive 412 used for storing content such as PIN inputs. The components 402, 404, 406, 408, 410, and 412 are interconnected by a data transport system (e.g., a bus) 414. A power supply unit (PSU) 416 provides power to components of the system 400 via a power transport system 418 (shown with data transport system 414, although the power and data transport systems may be separate).

It is understood that the system 400 may be differently configured and that each of the listed components may actually represent several different components. For example, the CPU 402 may actually represent a multi-processor or a distributed processing system; the memory unit 404 may include different levels of cache memory, and main memory; the I/O device 406 may include monitors, keyboards, touchscreens, and the like; the at least one network interface 408 may include one or more network cards providing one or more wired and/or wireless connections to a network 420; and the storage drive 412 may include hard disks and remote storage locations. Therefore, a wide range of flexibility is anticipated in the configuration of the system 400, which may range from a single physical platform configured primarily for a single user or autonomous operation to a distributed multi-user platform such as a cloud computing system.

The system 400 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 400. In some embodiments, the system 400 can be a compact system such as a Raspberry Pi running a Linux-based operating system such as Debian. The operating system, as well as other instructions (e.g., for telecommunications and/or other functions provided by the device 400), may be stored in the memory unit 404 and executed by the processor 402. For example, if the system 400 is, or is part of, the device 400, the memory unit 404 may include instructions for performing some or all of the steps, process, and methods described herein.

The network 420 may be a single network or may represent multiple networks, including networks of different types, whether wireless or wired. For example, the device 400 may be coupled to external devices via a network that includes a cellular link coupled to a data packet network or may be coupled via a data packet link such as a wide local area network (WLAN) coupled to a data packet network or a Public Switched Telephone Network (PSTN). Accordingly, many different network types and configurations may be used to couple the device 400 with external devices.

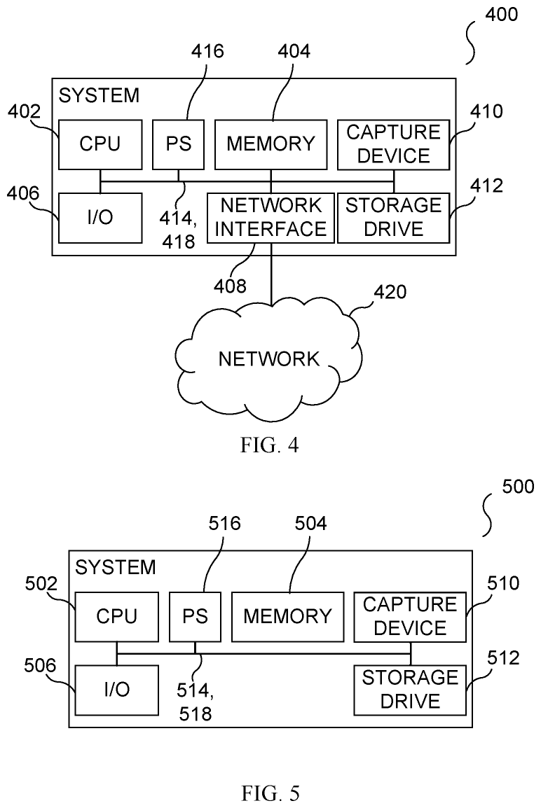

FIG. 5 illustrates an example electronic device 500 in accordance with various embodiments of this disclosure. The device 500 can be one example of a BNR device 100. The system 500 includes a controller (e.g., a processor/central processing unit (“CPU”)) 502, a memory unit 504, and an I/O device 506. The device 500 further includes at least one capture device 510 for capturing media or inputs to the system through an I/O device. In some embodiments, the capture device is not included. The device 500 also includes a storage drive 512 used for storing content such as PIN inputs. The components 502, 504, 506, 510, and 512 are interconnected by a data transport system (e.g., a bus) 514. A PSU 516 provides power to components of the system 500 via a power transport system 518 (shown with data transport system 514, although the power and data transport systems may be separate).

It is understood that the system 500 may be differently configured and that each of the listed components may actually represent several different components. For example, the CPU 502 may actually represent a multi-processor or a distributed processing system; the memory unit 504 may include different levels of cache memory, and main memory; the I/O device 506 may include monitors, keyboards, touchscreens, and the like; and the storage drive 512 may include hard disks and remote storage locations. Therefore, a wide range of flexibility is anticipated in the configuration of the system 500, which may range from a single physical platform configured primarily for a single user or autonomous operation to a distributed multi-user platform such as a cloud computing system.

The system 500 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., IOS, Android, RTOS, Blackberry, and/or Windows Phone), personal computers, servers, and other computing platforms depending on the use of the system 500. In some embodiments, the system 500 can be a compact system such as a Raspberry Pi running a Linux-based operating system such as Debian. The operating system, as well as other instructions (e.g., for telecommunications and/or other functions provided by the device 500), may be stored in the memory unit 504 and executed by the processor 502. For example, if the system 500 is, or is part of, the device 400, the memory unit 504 may include instructions for performing some or all of the steps, process, and methods described herein.

A dual use of a recycler for recycling banknotes in a regular operation and storing banknotes during feeding operation and apparatus is provided. The BNR device 100 includes a bunch note feeder 110, a recognition sensor 106, a plurality of recyclers 124, a transport path, and a processor. The bunch note feeder receives a bunch of banknotes. The recognition sensor 106 verifies authenticity of an inserted banknote. The plurality of recyclers temporarily stores designated the banknotes. The transport path can be provided between the bunch note feeder and the recyclers. The processor assigns a recycler as an escrow recycler 126. The processor determines whether any banknotes of the bunch of banknotes is unacceptable. If a banknote is unacceptable, the processor routes the unacceptable banknote to the escrow recycler 126; and after the bunch note feeder and transport path are empty, routes the unacceptable banknote from the escrow recycler 126 along the transport path to an outlet 112.

In another embodiment, a dual use of a friction based recycling module for recycling banknotes in a regular operation and storing banknotes during feeding operation and apparatus is provided. The BNR device 100 includes a bunch note feeder, a recognition sensor 106, a plurality of friction based recycling modules, a transport path, and a processor. The bunch note feeder receives a bunch of banknotes. The recognition sensor 106 verifies authenticity of a banknote. The plurality of friction based recycling modules temporarily stores designated the banknotes. The transport path can be provided between the bunch note feeder and the friction based recycling modules. The processor assigns a friction based recycling module as an escrow recycler 126; determines whether any banknotes of the bunch of banknotes is unacceptable; if a banknote is unacceptable, routes the unacceptable banknote to the escrow recycler 126; and after the bunch note feeder and transport path are empty, routes the unacceptable banknote from the escrow recycler 126 along the transport path to an outlet 112.

A dual use of a recycler for recycling banknotes in a regular operation and storing banknotes during feeding operation and apparatus is provided. The BNR device 100 includes a bunch note feeder, a plurality of recyclers, a transportation path, a recognition sensor, and a processor operably coupled to the bunch note feeder, the plurality of recyclers, the transportation path, and the recognition sensor. The bunch note feeder is configured to receive a banknote bunch. Each of the plurality of recyclers is a recycling drum configured to temporarily store banknotes of a designated denomination. The recognition sensor is positioned along the transport path and configured to verify acceptance of each banknote in the received banknote bunch. The processor is configured to assign a recycler as an escrow recycler. The processor is also configured to identify at least one unacceptable banknote in the banknote bunch. The processor is additionally configured to route the at least one unacceptable banknote to the escrow recycler based on the determination. The processor is further configured to, after the bunch note feeder and the transport path are empty, route the at least one unacceptable banknote from the escrow recycler along the transport path to an outlet.

In another embodiment, a method for use of a dual use of a recycler for recycling banknotes in a regular operation and storing banknotes during feeding operation and apparatus is provided. The method includes temporarily storing banknotes in a plurality of recyclers, wherein each recycler is a recycling drum for banknotes of a designated denomination. The method also includes receiving a banknote bunch in a bunch note feeder. Additionally, the method includes assigning a recycler as an escrow recycler. The method further includes separating and individually routing banknotes in the banknote bunch between the bunch note feeder and each recycler of a plurality of recyclers. The method also includes verifying authenticity of each banknote in the received banknote bunch. The method additionally includes identifying at least one unacceptable banknote in the banknote bunch. The method additionally includes routing the at least one unacceptable banknote to the escrow recycler based on the determination. The method also includes after the bunch note feeder and the transport path are empty, routing the at least one unacceptable banknote from the escrow recycler along the transport path to an outlet.

In yet another embodiment, a dual use of a friction based recycling module for recycling banknotes in a regular operation and storing banknotes during feeding operation and apparatus is provided. The BNR device includes a bunch note feeder, a plurality of recyclers, a transport path, a recognition sensor, and a processor operably coupled to the bunch note feeder, the plurality of recyclers, the transport path, and the recognition sensor. The bunch note feeder is configured to receive a banknote bunch. Each of the plurality of recyclers is a friction based recycling module configured to temporarily store banknotes of a designated denomination. The recognition sensor is positioned along the transport path and configured to verify acceptance of each banknote in the received banknote bunch. The processor is configured to assign a recycler as an escrow recycler. The processor is also configured to identify at least one unacceptable banknote in the banknote bunch. The processor is additionally configured to route the at least one unacceptable banknote to the escrow recycler based on the determination. The processor is further configured to, after the bunch note feeder and the transport path are empty, route the at least one unacceptable banknote from the escrow recycler along the transport path to an outlet.

In one or more of the above examples, to assign the escrow recycler the processor is configured to receive a user input identifying a specific recycler to use as the escrow recycler; and assign the escrow recycler based on the received user input.

In one or more of the above examples, the escrow recycler is assigned based on a specified denomination of a recycler.

In one or more of the above examples, the escrow recycler is assigned based on a depletion for each of the plurality of recyclers.

In one or more of the above examples, the processor is configured to determine that the escrow recycler does not have a minimum space available for a replenish operation; and empty an amount of banknotes stored in the escrow recycler prior to receiving the banknote bunch to a cashbox in order for the escrow recycler to have the minimum space available for the replenish operation.

In one or more of the above examples, the processor is further configured to, when the escrow recycler is full, purge the transport path and route the at least one unacceptable banknote from the escrow recycler to the outlet.

In one or more of the above examples, the processor is further configured to identify an acceptable banknote of a denomination corresponding to the escrow recycler; and transfer the acceptable banknote to a bundler when the at least one unacceptable banknote is already stored on the escrow recycler.

In various embodiments, a banknote recycler device can include a bunch note feeder, a plurality of recyclers, a transport path, a recognition sensors, and a processor operably coupled to the bunch note feeder, the recognition sensor, the transport path, and the plurality of recyclers. The bunch note feeder can receive a banknote bunch. Each of the plurality of recyclers can be a recycling drum configured to temporarily store banknotes of a designated denomination. The transport path can transport banknotes in the banknote bunch between the bunch note feeder and each of the plurality of recyclers. The recognition sensor can be positioned along the transport path and can verify acceptance of each banknote in the received banknote bunch. The processor can assign one of the plurality of recyclers as an escrow recycler. The processor can also identify at least one unacceptable banknote in the banknote bunch. The processor can additionally route the at least one unacceptable banknote to the escrow recycler based on the identification. The processor can further, after the bunch note feeder and the transport path are empty, route the at least one unacceptable banknote from the escrow recycler along the transport path to an outlet.

In certain embodiments, to assign the escrow recycler, the processor can receive a user input identifying a specific recycler to use as the escrow recycler and can assign the escrow recycler based on the received user input.

In certain embodiments, the escrow recycler can be assigned based on a specified denomination of a recycler.

In certain embodiments, the escrow recycler can be assigned based on a depletion for each of the plurality of recyclers.

In certain embodiments, the processor can determine that the escrow recycler does not have a minimum space available for a replenish operation. The processor can also empty an amount of banknotes stored in the escrow recycler prior to receiving the banknote bunch to a bundler in order for the escrow recycler to have the minimum space available for the replenish operation.

In certain embodiments, the processor can when the escrow recycler is full, purge the transport path and route the at least one unacceptable banknote from the escrow recycler to the outlet.

In various embodiments, a method is provided for a banknote recycler. The method can include temporarily storing banknotes in a plurality of recyclers, wherein each of the plurality of recyclers is a recycling drum for banknotes of a designated denomination. The method can also include receiving a banknote bunch in a bunch note feeder. The method can additionally include assigning one of the plurality of recyclers as an escrow recycler. The method can further include transporting banknotes in the banknote bunch along a transport path between the bunch note feeder and each recycler of a plurality of recyclers. The method can also include verifying authenticity of each banknote in the received banknote bunch. The method can further include identifying at least one unacceptable banknote in the banknote bunch. In addition, the method can include routing the at least one unacceptable banknote to the escrow recycler based on the identification. The method can also include after the bunch note feeder and the transport path are empty, routing the at least one unacceptable banknote from the escrow recycler along the transport path to an outlet.

In certain embodiments, the method can also include receiving a user input identifying a specific recycler to use as the escrow recycler. The method can further include assigning the escrow recycler based on the received user input.

In certain embodiments, the escrow recycler is assigned based on a specified denomination of a recycler.

In certain embodiments, the escrow recycler is assigned based on a depletion for each of the plurality of recyclers.

In certain embodiments, the method can also include determining that the escrow recycler does not have a minimum space available for a replenish operation. The method can further include emptying an amount of banknotes stored in the escrow recycler prior to receiving the banknote bunch to a cashbox in order for the escrow recycler to have the minimum space available for the replenish operation.

In certain embodiments, the method can additionally include when the escrow recycler is full, purging the transport path and routing the at least one unacceptable banknote from the escrow recycler to the outlet.

In certain embodiments, the method can also include identifying an acceptable banknote of a denomination corresponding to the escrow recycler. The method can further include transferring the acceptable banknote to a bundler when the at least one unacceptable banknote is already stored on the escrow recycler.

In various embodiments, a banknote recycler device can include a bunch note feeder, a plurality of recyclers, a transport path, a recognition sensor, and a processor operably coupled to the bunch note feeder, the recognition sensor, the transport path, and the plurality of recyclers. The bunch note feeder can receive a banknote bunch. Each of the plurality of recyclers can be a friction based recycling module configured to temporarily store banknotes of a designated denomination. The transport path can transport banknotes in the banknote bunch between the bunch note feeder and each of the plurality of recyclers. The recognition sensor can be positioned along the transport path and can verify acceptance of each banknote in the received banknote bunch. The processor can assign one of the plurality of recyclers as an escrow recycler. The processor can also identify at least one unacceptable banknote in the banknote bunch. The processor can additionally route the at least one unacceptable banknote to the escrow recycler based on the identification. The processor can further, after the bunch note feeder and the transport path are empty, route the at least one unacceptable banknote from the escrow recycler along the transport path to an outlet.

In certain embodiments, to assign the escrow recycler, the processor can receive a user input identifying a specific recycler to use as the escrow recycler and can assign the escrow recycler based on the received user input.

In certain embodiments, the escrow recycler can be assigned based on a specified denomination of a recycler.

In certain embodiments, the escrow recycler can be assigned based on a depletion for each of the plurality of recyclers.

In certain embodiments, the processor can determine that the escrow recycler does not have a minimum space available for a replenish operation. The processor can also empty an amount of banknotes stored in the escrow recycler prior to receiving the banknote bunch to a bundler in order for the escrow recycler to have the minimum space available for the replenish operation.

In certain embodiments, the processor can when the escrow recycler is full, purge the transport path and route the at least one unacceptable banknote from the escrow recycler to the outlet.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A banknote recycler (BNR) device comprising:
a bunch note feeder configured to receive a banknote bunch;
a plurality of recyclers, wherein each of the plurality of recyclers is a recycling drum configured to temporarily store banknotes of a designated denomination;
a transport path configured to transport banknotes in the banknote bunch between the bunch note feeder and each of the plurality of recyclers;
a recognition sensor positioned along the transport path and configured to verify acceptance of each banknote in the received banknote bunch; and
a processor operably coupled to the bunch note feeder, the recognition sensor, the transport path, and the plurality of recyclers, the processor configured to:
assign one of the plurality of recyclers as an escrow recycler,
identify at least one unacceptable banknote in the banknote bunch,
route the at least one unacceptable banknote to the escrow recycler based on the identification of the at least one unacceptable banknote, and
after the bunch note feeder and the transport path are empty, route the at least one unacceptable banknote from the escrow recycler along the transport path to an outlet.

2. The BNR of claim 1, wherein, to assign the escrow recycler, the processor is configured to:
receive a user input identifying a specific recycler to use as the escrow recycler; and
assign the escrow recycler based on the received user input.

3. The BNR of claim 1, wherein the escrow recycler is assigned based on a specified denomination.

4. The BNR of claim 1, wherein the escrow recycler is assigned based on a depletion for each of the plurality of recyclers.

5. The BNR of claim 1, wherein the processor is configured to:
determine that the escrow recycler does not have a minimum space available for a replenish operation; and
empty an amount of banknotes stored in the escrow recycler prior to receiving the banknote bunch to a cashbox in order for the escrow recycler to have the minimum space available for the replenish operation.

6. The BNR of claim 1, wherein the processor is further configured to:
when the escrow recycler is full, purge the transport path and route the at least one unacceptable banknote from the escrow recycler to the outlet.

7. The BNR of claim 1, wherein the processor is further configured to:
identify an acceptable banknote of a denomination corresponding to the escrow recycler; and
transfer the acceptable banknote to a bundler when the at least one unacceptable banknote is already stored on the escrow recycler.

8. A method for a banknote recycler (BNR) device comprising:
temporarily storing banknotes in a plurality of recyclers, wherein each of the plurality of recyclers is a recycling drum for banknotes of a designated denomination;
receiving a banknote bunch in a bunch note feeder;
assigning one of the plurality of recyclers as an escrow recycler, transporting banknotes in the banknote bunch along a transport path between the bunch note feeder and each recycler of the plurality of recyclers;
verifying authenticity of each banknote in the received banknote bunch;
identifying at least one unacceptable banknote in the banknote bunch;
routing the at least one unacceptable banknote to the escrow recycler based on the identification of the at least one unacceptable banknote; and
after the bunch note feeder and the transport path are empty, routing the at least one unacceptable banknote from the escrow recycler along the transport path to an outlet.

9. The method of claim 8, further comprising:
receiving a user input identifying a specific recycler to use as the escrow recycler; and
assigning the escrow recycler based on the received user input.

10. The method of claim 8, wherein the escrow recycler is assigned based on a specified denomination.

11. The method of claim 8, wherein the escrow recycler is assigned based on a depletion for each of the plurality of recyclers.

12. The method of claim 8, further comprising:
determining that the escrow recycler does not have a minimum space available for a replenish operation; and
emptying an amount of banknotes stored in the escrow recycler prior to receiving the banknote bunch to a cashbox in order for the escrow recycler to have the minimum space available for the replenish operation.

13. The method of claim 8, further comprising:
when the escrow recycler is full, purging the transport path and routing the at least one unacceptable banknote from the escrow recycler to the outlet.

14. The method of claim 8, further comprising:
identifying an acceptable banknote of a denomination corresponding to the escrow recycler; and
transferring the acceptable banknote to a bundler when the at least one unacceptable banknote is already stored on the escrow recycler.

15. A banknote recycler (BNR) device comprising:
a bunch note feeder configured to receive a banknote bunch;
a plurality of recyclers, wherein each of the plurality of recyclers is a friction based recycling module configured to temporarily store banknotes of a designated denomination;
a transport path configured to transport banknotes in the banknote bunch between the bunch note feeder and each of the plurality of recyclers;
a recognition sensor positioned along the transport path and configured to verify acceptance of each banknote in the received banknote bunch; and
a processor operably coupled to the bunch note feeder, the recognition sensor, the transport path, and the plurality of recyclers, the processor configured to:
assign one of the plurality of recyclers as an escrow recycler,
identify at least one unacceptable banknote in the banknote bunch,
route the at least one unacceptable banknote to the escrow recycler based on the identification of the at least one unacceptable banknote, and
after the bunch note feeder and the transport path are empty, route the at least one unacceptable banknote from the escrow recycler along the transport path to an outlet.

16. The BNR of claim 15, wherein, to assign the escrow recycler, the processor is configured to:
receive a user input identifying a specific recycler to use as the escrow recycler; and
assign the escrow recycler based on the received user input.

17. The BNR of claim 15, wherein the escrow recycler is assigned based on a specified denomination.

18. The BNR of claim 15, wherein the escrow recycler is assigned based on a depletion for each of the plurality of recyclers.

19. The BNR of claim 15, wherein the processor is configured to:
determine that the escrow recycler does not have a minimum space available for a replenish operation; and
empty an amount of banknotes stored in the escrow recycler prior to receiving the banknote bunch to a bundler in order for the escrow recycler to have the minimum space available for the replenish operation.

20. The BNR of claim 15, wherein the processor is further configured to:
when the escrow recycler is full, purge the transport path and route the at least one unacceptable banknote from the escrow recycler to the outlet.
